(19) United States
(12) Patent Application Publication
(10) Pub. No.: US 2010/0153664 A1
(43) Pub. Date: Jun. 17, 2010

(54) CONTROLLER AND STORAGE DEVICE FOR CHANGING SEQUENTIAL ORDER OF EXECUTING COMMANDS

(75) Inventor: Osamu Yoshida, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/638,873

(22) Filed: Dec. 15, 2009

(30) Foreign Application Priority Data
Dec. 15, 2008 (JP) 2008-317887

(51) Int. Cl. G06F 12/00

(52) U.S. Cl. 711/156; 711/167; 711/E12.001

(57) ABSTRACT

According to one embodiment, a controller includes: a memory configured to hold commands pre-assigned with a sequential order of execution and to hold for each of the commands a waiting time indicating an elapsed time period from a time point at which the command started being held; a selector configured to select from the commands N commands having the longest waiting times, where N is an integer equal to or greater than one; a classifier configured to classify the commands into N+1 groups so that each of the N commands selected by the selector belongs to a different group; and a changer configured to assign priorities to the N+1 groups based on the waiting times of the N commands selected by the selector, and to change the sequential order of execution for the commands so that commands belonging to a group having a high priority are executed first.

### CROSS-REFERENCE TO RELATED APPLICATIONS

This application is based upon and claims the benefit of priority from Japanese Patent Application No. 2008-317887, filed on Dec. 15, 2008, the entire contents of which are incorporated herein by reference.

### BACKGROUND

1. Field

One embodiment of the invention relates to a technology for changing a sequential order of execution for commands executed at an electronic device, and more particularly, a reordering technology for changing a sequential order of execution for commands to access a storage medium such as a magnetic disk.

2. Description of the Related Art

A so-called reordering process of holding in a disk device connected to an upper device (host computer) a plurality of commands issued by the upper device and determining a sequential order of execution for the plurality of commands has been known. The Native Command Queuing (NCQ) command executed at the Serial ATA interface is one known reordering process. Further, there is a technology for calculating a sequential order of execution based on a waiting time such as a seek time to execute a process in a short period of time (Japanese Patent Application Publication (KOKAI) No. 2003-308176). In such a reordering process, a sequential order of execution for commands held in the disk device is determined based on access destinations of the commands on the disk. According to the determined sequential order of execution, consecutive accesses to a recording disk are performed effectively.

Furthermore, as another reordering process, a technology for prioritizing execution of a command that has kept being held in a disk device, i.e., a command that has been waiting for a long time to be executed. Such a technique is useful in voice data reproduction. The technique contributes to prevention of sound skipping. Specifically, there is a technology of raising a priority of a held command every time a predetermined number of executions have been performed, based on a number of command executions (Japanese Patent Application Publication (KOKAI) No. H5-134810). In addition, there is a technology of prioritizing a process by a command, if the process by the command has been caused to keep waiting for a predetermined time period or longer (Japanese Patent Application Publication (KOKAI) No. 2001-249770).

Recently, the number of commands held in an NCQ device (command queuing number) has increased due to the improvement in the hardware technology, and may increase further in the future. Thus, a situation is expected, in which a plurality of commands with long waiting time periods are simultaneously being held, causing sound skipping. In such a situation, sound skipping cannot be prevented just by performing consecutive accesses to a recording medium effectively. It may also be impossible to perform consecutive accesses to a recording medium effectively just by prioritizing execution of a command with a long waiting time period. Therefore, a technology to achieve effective consecutive accesses to a recording medium while prioritizing execution of a command that has been waiting for a long time period to be executed is desired.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a structure of a hard disk drive according to a first embodiment of the invention;

FIG. 2 is an exemplary schematic of commands and data associated thereto stored and held in a command memory in the first embodiment;

FIG. 3 is an exemplary functional block diagram for realizing a sequential-order-of-execution changing process and a command execution process in the first embodiment;

FIG. 4 is an exemplary flowchart of the exemplary sequential-order-of-execution changing process in the first embodiment;

FIG. 5 is an exemplary schematic for explaining a command classification in the first embodiment;

FIG. 6 is an exemplary schematic of the commands illustrated in FIG. 5 after a sequential order of execution is changed in the first embodiment;

FIG. 7 is an exemplary schematic for explaining another command classification in the first embodiment;

FIG. 8 is an exemplary schematic of the commands illustrated in FIG. 7 after a sequential order of execution is changed in the first embodiment;

FIG. 9 is an exemplary functional block diagram for realizing an exemplary sequential-order-of-execution changing process and a command execution process according to a second embodiment of the invention;

FIG. 10 is an exemplary flowchart of the sequential-order-of execution changing process in the second embodiment;

FIG. 11 is an exemplary schematic for explaining a command classification in the second embodiment;

FIG. 12 is an exemplary schematic of the commands illustrated in FIG. 11 after a sequential-order-of-execution is changed in the second embodiment;

FIG. 13 is an exemplary schematic for explaining another command classification in the second embodiment;

FIG. 14 is an exemplary schematic of the commands illustrated in FIG. 13 after a sequential-order-of-execution is changed in the second embodiment; and

FIG. 15 is an exemplary flowchart of a process according to variations of the first and the second embodiments.

### DETAILED DESCRIPTION

Various embodiments according to the invention will be described hereinafter with reference to the accompanying drawings. In general, according to one embodiment of the invention, a controller comprises: a memory configured to hold a plurality of commands pre-assigned with a sequential order of execution and to hold for each of the plurality of commands a waiting time indicating an elapsed time period from a time point at which the command started being held; a selector configured to select from the plurality of commands N command or commands having the longest waiting time or times, where N is an integer equal to or greater than one; a classifier configured to classify the plurality of commands into N+1 groups so that each of the N command or commands selected by the selector belongs to a different group; and a changer configured to assign priorities to the N+1 groups based on the waiting time or times of the N command or commands selected by the selector, and to change the sequential order of execution for the plurality of commands so that commands belonging to a group having a high priority are executed first.

According to another embodiment of the invention, a controller comprises: a memory configured to hold a plurality of commands pre-assigned with a sequential order of execution; a relation value calculator configured to calculate, for each of the plurality of commands, a relation value indicating a relationship between adjacent commands in the sequential order of execution; a classifier configured to classify the plurality of commands into a plurality of groups based on the relation value calculated for each of the plurality of commands; an extractor configured to extract, for each of the plurality of groups, a command having a longest waiting time indicating an elapsed time period from a time point at which the command started being held in the memory; and a changer configured to assign priorities to the plurality of groups based on the waiting times extracted by the extractor, and to change the sequential order of execution for the plurality of commands so that commands belonging to a group having a high priority are executed first.

According to still another embodiment of the invention, a storage device comprises: a memory configured to hold a plurality of commands pre-assigned with a sequential order of execution and to hold for each of the plurality of commands a waiting time indicating an elapsed time period from a time point at which the command started being held; a selector configured to select from the plurality of commands N command or commands having the longest waiting time or times, where N is an integer equal to or greater than one; a classifier configured to classify the plurality of commands into N+1 groups so that each of the N command or commands selected by the selector belongs to a different group; a changer configured to assign priorities to the N+1 groups based on the waiting time or times of the N command or commands selected by the selector, and to change the sequential order of execution for the plurality of commands so that commands belonging to a group having a high priority are executed first; and a command executor configured to sequentially execute the plurality of commands in accordance with the sequential order of execution changed by the changer.

According to still another embodiment of the invention, a storage device comprises: a memory configured to hold a plurality of commands pre-assigned with a sequential order of execution; a relation value calculator configured to calculate, for each of the plurality of commands, a relation value indicating a relationship between adjacent commands in the sequential order of execution; a classifier configured to classify the plurality of commands into a plurality of groups based on the relation value calculated for each of the plurality of commands; an extractor configured to extract, for each of the plurality of groups, a command having a longest waiting time indicating an elapsed time period from a time point at which the command started being held in the memory; a changer configured to assign priorities to the plurality of groups based on the waiting times extracted by the extractor, and to change the sequential order of execution for the plurality of commands so that commands belonging to a group having a high priority are executed first; and a command executor configured to sequentially execute the plurality of commands in accordance with the sequential order of execution changed by the changer.

A first embodiment of the invention will now be explained with reference to the drawings.

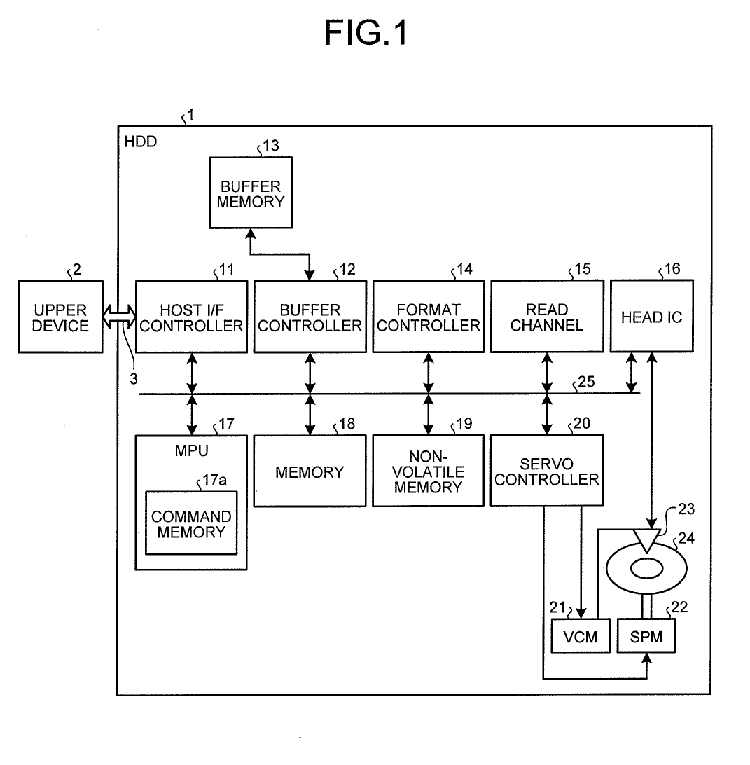

To begin with, a structure of a hard disk drive (HDD) that is a storage device according to the first embodiment will be explained. FIG. 1 is an exemplary block diagram of a structure of a HDD 1 connected to a higher-layer device (host computer) 2.

As depicted in FIG. 1, the upper device 2 and the HDD 1 are connected via a host interface (I/F) 3. The upper device 2 is a personal computer having the HDD 1 as a storage device, and issues a command to the HDD 1 upon reading and writing data therefrom and thereto.

The HDD 1 comprises a host interface (IF) controller 11, a buffer controller 12, a buffer memory 13, a format controller 14, a read channel 15, a head integrated circuit (IC) 16, a microprocessor unit (MPU) 17, a memory 18, a nonvolatile memory 19, a servo controller 20, a voice coil motor (VCM) 21, a spindle motor (SPM) 22, a read-and-write head 23, a disk medium 24, a bus 25, and the host I/F 3.

The host I/F 3 is responsible for communications between the HDD 1 and the upper device 2 transmitting and receiving data or commands. The host I/F controller 11 controls data or commands transmitted to the upper device 2 via the host I/F 3. The host I/F controller 11 also controls data or commands that are transmitted from the upper device 2 and received on the host I/F 3. The buffer controller 12 controls a writing or reading operation of data stored in the buffer memory 13. The buffer memory 13 temporarily stores therein data to be written into the disk medium 24 or read therefrom. The format controller 14 generates a writing format for data to be written into the disk medium 24. The read channel 15 converts data to be written into the disk medium 24 into a form of a signal, or converts a signal read from the disk medium 24 back into a form of data.

The head IC 16 amplifies a signal to be written into the disk medium 24 or a signal read therefrom by the read-and-write head 23. The MPU 17 controls the overall operations of the HDD 1. The MPU 17 comprises a command memory 17a to be explained later. The memory 18 is a volatile memory. The nonvolatile memory 19 stores therein computer programs for controlling the HDD 1. The servo controller 20 controls operations of the VCM 21 and the SPM 22. The VCM 21 drives the read-and-write head 23. The SPM 22 drives the disk medium 24 to rotate. The read-and-write head 23 writes data into the disk medium 24 in the form of a signal, or reads data recorded therein in the form of a signal. The disk medium 24 is a storage medium for recording therein data. The bus 25 is responsible for transmitting and receiving data or commands exchanged between the host I/F controller 11, the buffer controller 12, the format controller 14, the read channel 15, the head IC 16, the MPU 17, the memory 18, the nonvolatile memory 19, and the servo controller 20.

A transmission path of data to be transmitted or received, or a received command will now be explained briefly. To begin with, a transmission path of data read from the disk medium 24 will be explained briefly. The read-and-write head 23 reads data from the disk medium 24 in the form of a signal. The read signal is sent to the read channel 15 via the head IC 16. The signal sent to the read channel 15 is converted into the form of data. The converted data is sent to the buffer memory 13 via the format controller 14 and the buffer controller 12, and temporarily stored in the buffer memory 13. The data stored in the buffer memory 13 is output to the upper device 2 through the host I/F 3 under the control of the host I/F controller 11.

A transmission path of data to be written into the disk medium 24 will now be explained briefly. Data output from the upper device 2 goes through the host I/F 3, the host I/F controller 11, and the buffer controller 12, and is temporarily stored in the buffer memory 13. The data stored in the buffer memory 13 is transmitted to the read-and-write head 23 at the timing appropriate for the write operation via the format controller 14, the read channel 15, and the head IC 16. In the read channel 15, the data is converted into the form of a signal for the writing operation. The read-and-write head 23 then writes the converted signal into the disk medium 24.

A transmission path of a command issued from the upper device 2 will now be explained briefly. The upper device 2 issues a command to the HDD 1, instructing thereto a writing operation or a reading operation of data. The command is received on the host I/F 3, and transferred to the MPU 17 by way of the host I/F controller 11. The MPU 17 stores the received command in the command memory 17a. The MPU 17 counts, for each command, the time elapsed since the data is received. When a plurality of commands is held in the command memory 17a, the MPU 17 executes the commands in accordance with the sequential-order-of-execution the commands are assigned with.

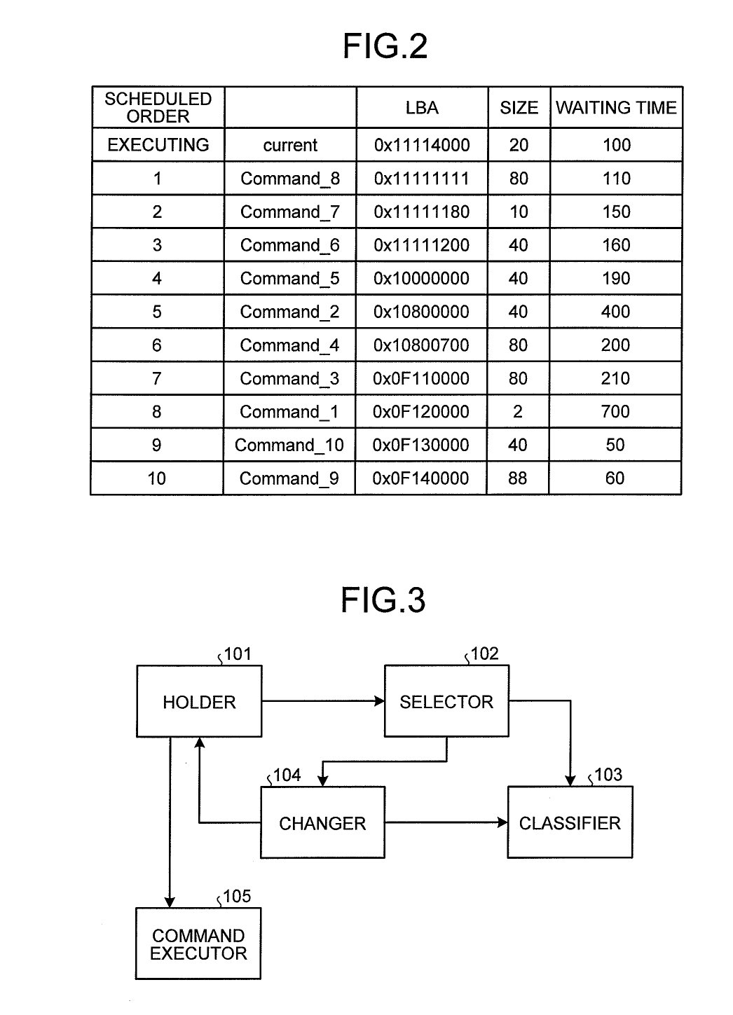

The command memory 17a comprised in the MPU 17 will be now explained. FIG. 2 is an exemplary schematic of commands and data associated thereto stored and held in the command memory 17a. As mentioned earlier, the command memory 17a is capable of holding a plurality of commands. According to the first embodiment, the command memory 17a is capable of storing and holding therein ten commands at once (Command_1 to Command_10) in addition to a current command. As depicted in FIG. 2, a sequential order of execution, indicating a scheduled sequential order of execution, is assigned to each of the commands excluding the current one. The sequential order of execution is assigned by NCQ that the MPU 17 performs as appropriate. The command memory 17a holds, for each of these commands, a logical address block (LAB) accessed by execution of the command. The command memory 17a also holds a size (SIZE) of data written or read by execution of the command. For example, the Command_8 is to be executed after the current command. The Command_1 has the longest time elapsed since reception thereof; in other words, the Command_1 is kept waiting for the longest time.

A sequential-order-of-execution changing function according to the first embodiment will now be explained.

FIG. 3 is a functional block diagram for realizing a sequential-order-of-execution changing process and a command execution process according to the first embodiment. The sequential-order-of-execution changing process is realized by a holder 101, a selector 102, a classifier 103, and a changer 104. The command executing process is realized by a command executor 105. The holder 101 holds a plurality of commands pre-assigned with a sequential order of execution. The holder 101 also holds, for each of the commands, a waiting time indicating an elapsed time period from a time at which the command started being held. The selector 102 selects N command(s) from these commands, beginning from those with a longer waiting time. N herein is an integer equal to or more than one. The classifier 103 classifies the commands held in the holder 101 into N+1 groups so that each of the N command(s) selected by the selector 102 belongs to a different group.

The changer 104 assigns a priority to each of the groups held by the holder 101 based on the waiting time of the N command(s) selected by the selector 102. More specifically, the changer 104 assigns a higher priority to a group including a command having a longer waiting time. If there is a plurality of commands having a long waiting time, the changer 104 assigns a priority, beginning from the group including a command with the longest waiting time. The changer 104 also changes the sequential order of execution for the commands held by the holder 101 so that those in a group with a higher priority are executed first. When a plurality of commands belongs to a single group, the changer 104 changes the sequential order of execution for the commands within such a group, reflecting the sequential order of execution pre-assigned thereto. The command executor 105 then sequentially executes the commands held by the holder 101 according to the sequential order of execution changed by the changer 104.

The holder 101 may be realized by the command memory 17a. The selector 102, the classifier 103, the changer 104, and the command executor 105 may be realized by the MPU 17 executing predetermined computer programs.

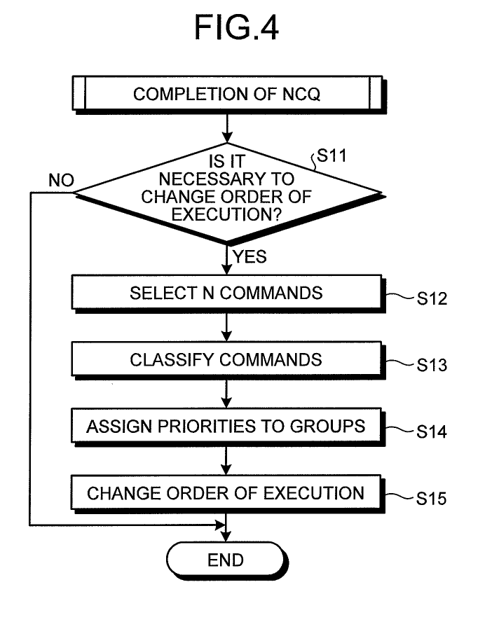

A sequential-order-of-execution changing process according to the first embodiment will now be explained with reference to the structure depicted in FIG. 1. FIG. 4 is a flowchart of the sequential-order-of-execution changing process. In this example, it is assumed that the MPU 17 executes the NCQ to assign a sequential order of execution to each of the commands held in the command memory 17a. It is also assumed herein that commands and data associated thereto, such as those depicted in FIG. 2, are held in the command memory 17a.

The MPU 17 determines whether it is necessary to change the sequential order of execution for the commands held in the command memory 17a (S11). If the MPU 17 determines that it is not necessary to change the sequential order of execution (No at S11), the process is ended. The MPU 17 may determine if a change is necessary based on the presence of a command having a waiting time longer than a predetermined time.

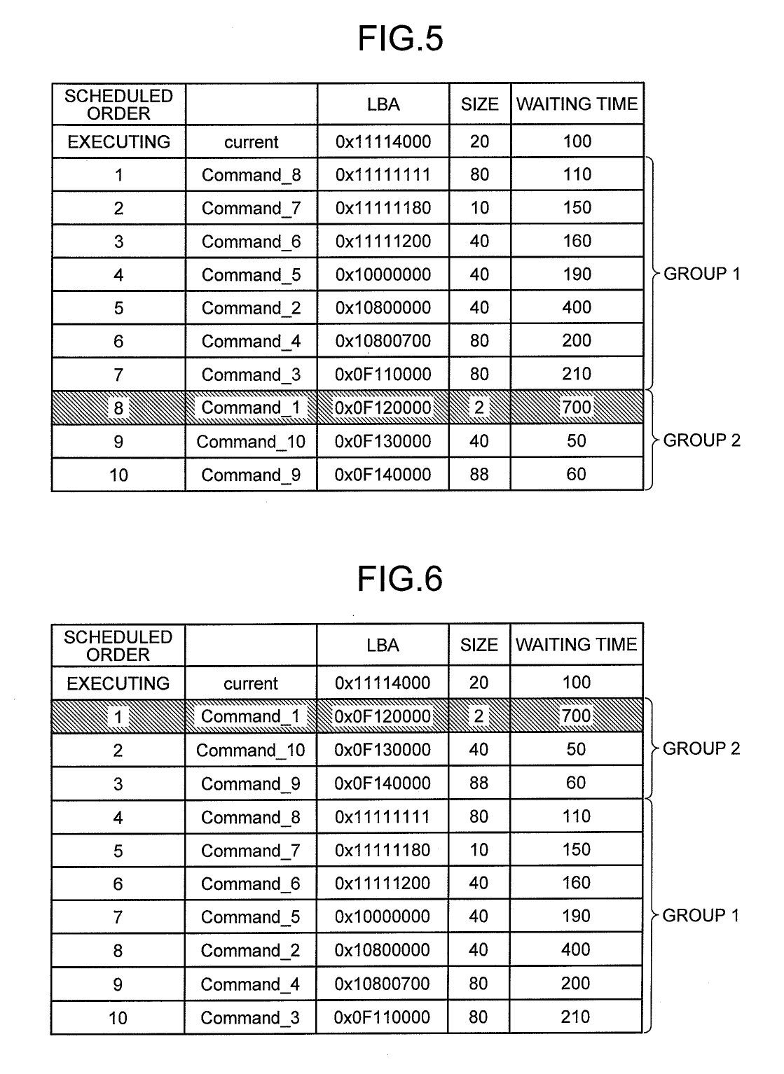

If the MPU 17 determines that the sequential order of execution needs to be changed (Yes at S11), the MPU 17 selects N command(s) from the commands held in the holder 101 based on the waiting time of each of these commands, beginning from those with a longer waiting time (S12). N herein is an integer equal to or more than one. N may be a predetermined number. Alternatively, N may be determined based on the number of commands held in the command memory 17a. According to the first embodiment, the MPU 17 selects N command(s) from the commands held in the command memory 17a, beginning from those with a longer waiting time. For example, when N=1, the MPU 17 selects the Command_1 (see FIG. 5).

The MPU 17 then classifies the commands held in the command memory 17a into N+1 groups, based on the selected N command(s) (S13). According to the first embodiment, the MPU 17 classifies the commands held in the command memory 17a into a plurality of groups so that each of the selected N command(s) comes to the top of the sequential order of execution in the group corresponding thereto. For example, when N=1, the MPU 17 assigns the Command_10 and the Command_9, both assigned with a sequential order of execution to follow the Command_1, to the same group as the Command_1 (Group 2 depicted in FIG. 5). The MPU 17 assigns the remaining commands excluding the Command_1, the Command_9, and the Command_10 to a single group (Group 1 depicted in FIG. 5). As a result, the Command_8, the Command_7, the Command_6, the Command_5, the Command_2, the Command_4, and the Command_3 belong to the Group 1; and the Command_1, the Command_10, and the Command_9 belong to the Group 2.

The MPU 17 then assigns a priority to each of the groups classified at S13 based on the waiting time of each of the N command(s) selected at S12 (S14). When N=1, the MPU 17 assigns a higher priority to the Group 2 including the Command_1 selected at S12 than that assigned to the Group 1. In this example, none of the selected command belongs to the Group 1; therefore, a higher priority is assigned to the Group 2 than that assigned to the Group 1.

The MPU 17 also changes the sequential order of execution for the commands held in the command memory 17a based on the priorities assigned to the Group 1 and the Group 2 and the sequential order of execution the NCQ assigned thereto (S15). When N=1, the sequential order of execution is assigned so that the commands belonging to the Group 2 are executed first. Because a plurality of commands belongs to the same group, a new sequential order of execution is assigned to the commands, reflecting the sequential order of execution the NCQ assigned thereto. FIG. 6 is a schematic of the commands held in the command memory 17a after the sequential order of execution is changed. More specifically, the Command_1 is assigned with a sequential order of execution ranking “1”; the Command_10 is assigned with a sequential order of execution ranking “2”; and the Command_9 is assigned with a sequential order of execution ranking “3”. Upon completing assigning the new sequential order of execution to the commands belonging to the Group 2, the MPU 17 also assigns a new sequential order of execution to the commands belonging to the Group 1. Because a plurality of commands also belongs to the same group, a new sequential order of execution is assigned to the commands, reflecting the sequential order of execution the NCQ assigned thereto. More specifically, the Command_8 is assigned with a sequential order of execution ranking “4”; the Command_7 is assigned with a sequential order of execution ranking “5”; the Command_6 is assigned with a sequential order of execution ranking “6”; the Command_5 is assigned with a sequential order of execution ranking “7”; the Command_2 is assigned with a sequential order of execution ranking “8”; the Command_4 is assigned with a sequential order of execution ranking “9”; and the Command_3 is assigned with a sequential order of execution ranking “10”.

In this manner, the sequential-order-of-execution changing process is completed. The MPU 17 then sequentially executes the commands held in the command memory 17a in accordance with the sequential order of execution changed at S15.

In the explanation above, it is explained specifically how the MPU 17 operates when N=1; in the explanation hereafter, it will be explained specifically how the MPU 17 operates when N=2.

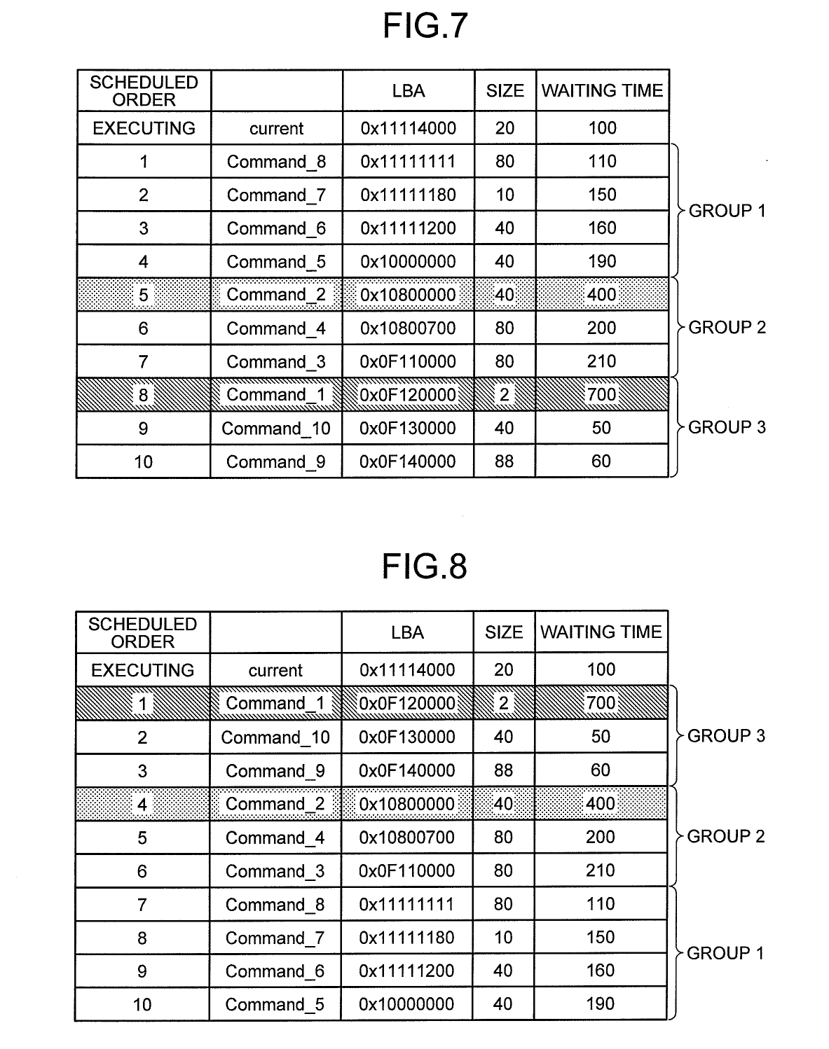

When N=2, the MPU 17 selects the Command_1 and the Command_2 (S12; see FIG. 7). At S13, the MPU 17 assigns the Command_10 and the Command_9 assigned with a sequential order of execution to follow the Command_1 to the same group as the Command_1 (Group 3 depicted in FIG. 7). The MPU 17 assigns the Command_4 and the Command_3 assigned with a sequential order of execution to follow the Command_2 to the same group as the Command_2 (Group 2 depicted in FIG. 7). The other commands excluding the Command_1, the Command_2, the Command_3, the Command_4, the Command_9, and the Command_10 are assigned to a single group (Group 1 depicted in FIG. 7). As a result, the Command_8, the Command_7, the Command_6, and the Command_5 belong to the Group 1; the Command_2, the Command_4, and the Command_3 belong to the Group 2; and the Command_1, the Command_10, and the Command_9 belong to the Group 3.

At S14, the MPU 17 assigns a highest priority to the Group 3, and down to the Group 2 and the Group 1. The MPU 17 assigns a higher priority to the Group 3 including the Command_1 than that is assigned to the Group 2 including the Command_2. This is because the Command_1 has a longer waiting time than the Command_2.

At S15, a sequential order of execution is assigned so that the commands belonging to the Group 3 are executed first. Because a plurality of commands belongs to the single group, these commands are assigned with new sequential order of execution, reflecting those the NCQ assigned thereto. FIG. 8 is a schematic of the commands held in the command memory 17a after the sequential order of execution is changed. More specifically, the sequential order of execution ranking “1” is assigned to the Command_1; the sequential order of execution ranking “2” is assigned to the Command_10; and the sequential order of execution ranking “3” is assigned to the Command_9. Upon completing assigning the new sequential order of execution to the commands belonging to the Group 3, the MPU 17 assigns a new sequential order of execution to the commands belonging to the Group 2. More specifically, the sequential order of execution ranking “4” is assigned to the Command_2; the sequential order of execution ranking “5” is assigned to the Command_4; and the sequential order of execution ranking “6” is assigned to the Command_3. Upon completing assigning the new sequential order of execution to the commands belonging to the Group 2, the MPU 17 assigns a new sequential order of execution to the commands belonging to the Group 1. More specifically, the sequential order of execution ranking “7” is assigned to the Command_8; the sequential order of execution ranking “8” is assigned to the Command_7; the sequential order of execution ranking “9” is assigned to the Command_6; and the sequential order of execution ranking “10” is assigned to the Command_5.

According to the first embodiment, a command having a longer waiting time can be executed at a higher priority, while allowing effective consecutive accesses determined by the NCQ.

A second embodiment of the invention will now be explained with reference to the drawings. A storage device according to the second embodiment may be realized as a hard disk drive (HDD). The HDD according to the second embodiment may be structured in the same manner as that explained in the first embodiment. Therefore, explanations of individual modules comprised therein will be omitted herein. Upon referring to each of these individual modules, the same reference numerals as those used in FIG. 1 will be used.

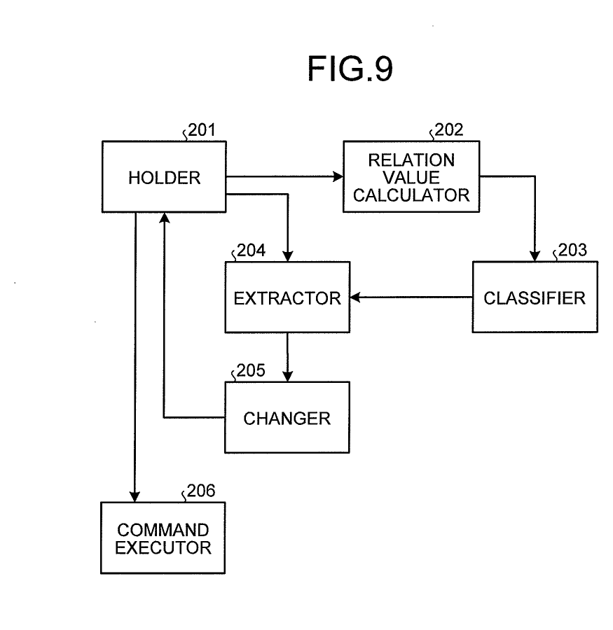

A sequential-order-of-execution changing function according to the second embodiment will now be explained. FIG. 9 is a functional block diagram for realizing a sequential-order-of-execution changing process and a command execution process according to the second embodiment. The sequential-order-of-execution changing process is achieved by a holder 201, a relation value calculator 202, a classifier 203, an extractor 204, and a changer 205. The command executing process is achieved by a command executor 206.

The holder 201 holds a plurality of commands each pre-assigned with a sequential order of execution. The relation value calculator 202 calculates, for each of the commands held in the holder 201, a relation value representing a relationship between commands having adjacent rankings in the sequential order of execution. The classifier 203 classifies the commands held in the holder 201 into a plurality of groups based on the relation value of each of the commands. The extractor 204 extracts, from each of the groups, a command that is kept waiting for the longest time since such a command comes to be held in the holder 201. The changer 205 assigns a priority to each of the groups classified by the classifier 203 based on the waiting time of the extracted commands. The changer 205 also changes the sequential order of execution for the commands held in the holder 201 so that the commands belonging to a group with a higher priority are executed first. More specifically, the changer 205 compares the waiting time of the extracted commands, and assigns a higher priority to the group including a command with a longer waiting time. In other words, the changer 205 assigns priorities to commands in the descending order of the length of the waiting time of the extracted commands. If a plurality of commands belongs to a single group, the changer 205 changes the sequential order of execution for the commands in the group, reflecting a pre-assigned sequential order of execution. The command executor 206 sequentially executes the commands held by the holder 201 according to the sequential order of execution changed by the changer 205.

For commands having adjacent rankings in the sequential order of execution, the relation value calculator 202 may calculate, as a relation value, a transition time period from the completion of the command having the prior ranking in the sequential order of execution to the start time of execution of the command having the subsequent ranking in the sequential order of execution.

For commands having adjacent rankings in the sequential order of execution, the relation value calculator 202 may also calculate, as a relation value, the difference between the logical address accessed by the command having the prior ranking in the sequential order of execution, and the logical address accessed by the command having the subsequent ranking in the sequential order of execution.

The holder 201 may be realized by using the command memory 17a. The relation value calculator 202, the classifier 203, the extractor 204, the changer 205, and the command executor 206 may be realized by the MPU 17 executing predetermined computer programs.

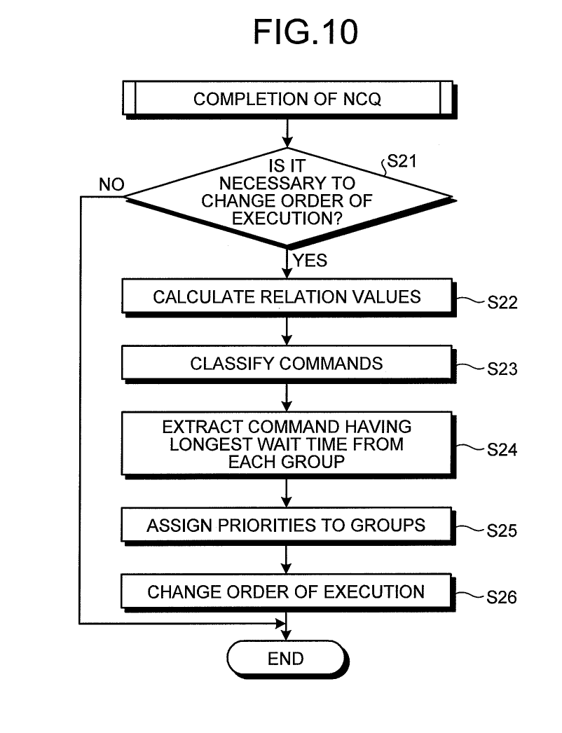

A sequential-order-of-execution changing process according to the second embodiment will now be explained with reference to the structure depicted in FIG. 1. FIG. 10 is a flowchart of the sequential-order-of-execution changing process. In this example, it is assumed that the MPU 17 executes the NCQ to assign a sequential order of execution to each of the commands held in the command memory 17a. It is also assumed herein that commands and data associated thereto, such as those depicted in FIG. 2, are held in the command memory 17a.

The MPU 17 determines whether it is necessary to change the sequential order of execution for the commands held in the command memory 17a (S21). If the MPU 17 determines that it is not necessary to change the sequential order of execution (No at S21), the process is ended.

If the MPU 17 determines that the sequential order of execution need to be changed (Yes at S21), the MPU 17 calculates, for each of the commands held in the command memory 17a, a relation value representing a relationship between commands having adjacent rankings in the sequential order of execution, based on the waiting time of each of these commands (S22). For commands having adjacent rankings in the sequential order of execution, the MPU 17 may calculate, as a relation value, a transition time period from the completion of the command having the prior ranking in the sequential order of execution to the start time of execution of the command having the subsequent ranking in the sequential order of execution. For example, when a calculation is performed, in the process of executing the NCQ, as to how much time is required to move the head to a sector to be processed by Command_N assigned with a ranking in the sequential order of execution subsequent to that of Command_M after completing processing the Command_M, such required time may be used as the relation value.

For commands having adjacent rankings in the sequential order of execution, the MPU 17 may also calculate, as a relation value, the difference between the logical address accessed by the command having the prior ranking in the sequential order of execution and the logical address accessed by the command having the subsequent ranking in the sequential order of execution.

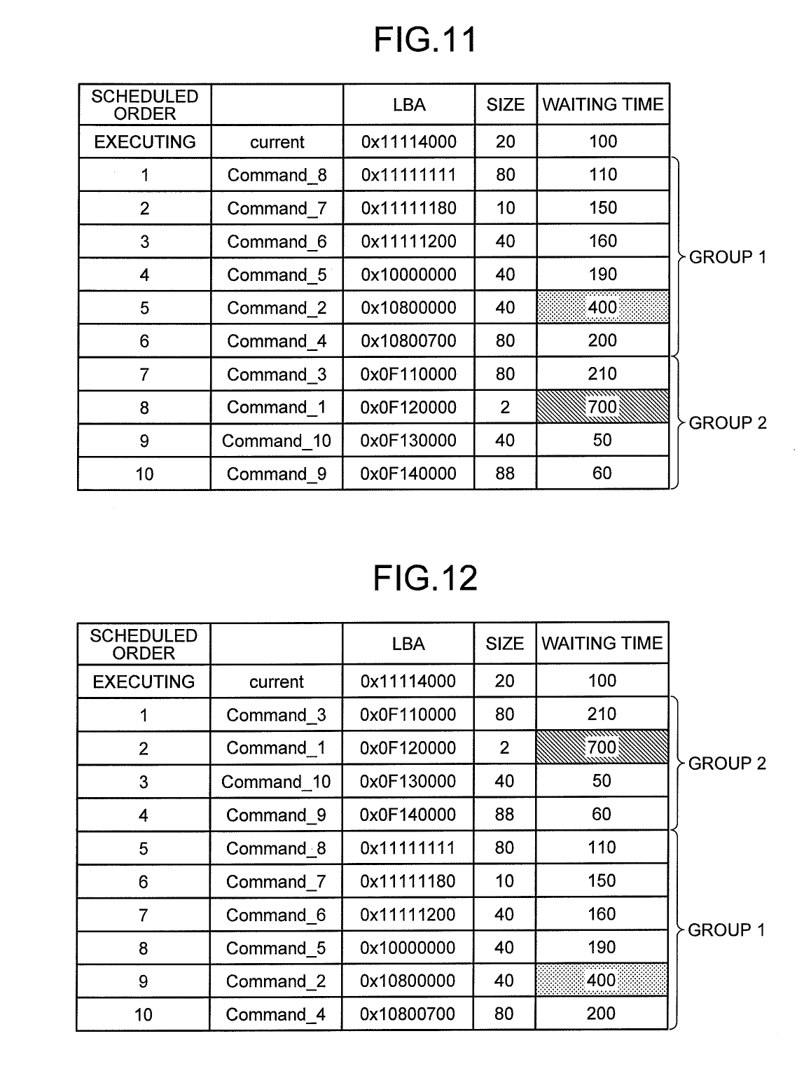

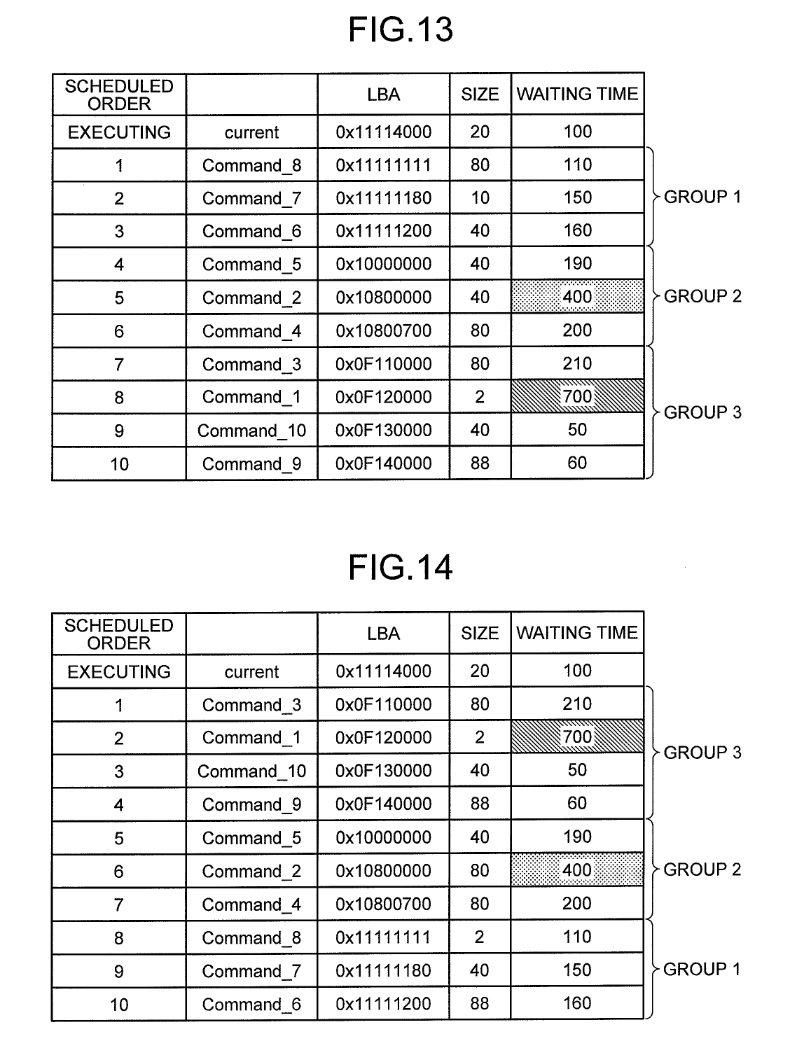

The MPU 17 then classifies the commands held in the command memory 17a into a plurality of groups, based on the relation value of each of the commands (S23). For example, as a relation value between the Command_4 and the Command_3, a value 0×016f0780 is calculated by referring to LBAs; and a value 0×016f0780 is calculated as a relation value between the Command_6 and the Command_5. The commands may be classified into two groups as depicted in FIG. 11, or into three groups as depicted in FIG. 13 based on such relation values. The number of groups may be predetermined. Alternatively, the number may be determined based on the number of commands held in the command memory 17a.

The MPU 17 extracts, for each of the classified groups, a command that is kept waiting for the longest time since the command comes to be held in the command memory 17a (S24). If the commands held in the command memory 17a are classified into two groups, the MPU 17 selects the Command_1 and the Command_2 (see FIG. 11). If the commands held in the command memory 17a are classified into three groups, the MPU 17 selects the Command_1, the Command_2, and the Command_6 (see FIG. 13).

The MPU 17 assigns a priority to each of the groups classified at S23 based on the waiting time of the extracted commands (S25). If the commands held in the command memory 17a are classified into two groups, the MPU 17 assigns a higher priority to the Group 2 than that assigned to the Group 1. This is because the waiting time of the Command_1 is longer than that of the Command_2. If the commands held in the command memory 17a are classified into three groups, the MPU 17 assigns the highest priority to the Group 3, and down to the Group 2 and the Group 1. The MPU 17 assigns a higher priority to the Group 3 including the Command_1 than that assigned to Group 2 including the Command_2. This is because the waiting time of the Command_1 is longer than that of the Command_2. The MPU 17 assigns a higher priority to the Group 2 including the Command_2 than that assigned to the Group 1 including the Command_6. This is because the waiting time of the Command_2 is longer than that of the Command_6.

The MPU 17 changes the sequential order of execution of the commands held in the command memory 17a based on these priorities and the pre-assigned sequential order of execution (S26). If the commands held in the command memory 17a are classified into two groups, the MPU 17 assigns the sequential order of execution so that the commands belonging to the Group 2 are executed first. Because a plurality of commands belongs to the single group, the MPU 17 assigns a new sequential order of execution to the commands, in accordance with the sequential order of execution assigned thereto by the NCQ. More specifically, the sequential order of execution ranking “1” is assigned to the Command_3; the sequential order of execution ranking “2” is assigned to the Command_1; the sequential order of execution ranking “3” is assigned to the Command_10; and the sequential order of execution ranking “4” is assigned to the Command_9. Upon completing assigning the new sequential order of execution to the commands belonging to the Group 2, the MPU 17 assigns a new sequential order of execution to the commands belonging to the Group 1. More specifically, the sequential order of execution ranking “5” is assigned to the Command_8; the sequential order of execution ranking “6” is assigned to the Command_7; the sequential order of execution ranking “7” is assigned to the Command_6; the sequential order of execution ranking “8” is assigned to the Command_5; the sequential order of execution ranking “9” is assigned to the Command_2; and the sequential order of execution ranking “10” is assigned to the Command_4. As a result, a new sequential order of execution depicted in FIG. 12 is assigned to the commands held in the command memory 17a.

If the commands held in the command memory 17a are classified into three groups, the MPU 17 assigns the sequential order of execution so that the commands belonging to the Group 3 are executed first. Because a plurality of commands belongs to the single group, the MPU 17 assigns a new sequential order of execution to the commands, in accordance with the sequential order of execution assigned thereto by the NCQ. More specifically, the sequential order of execution ranking “1” is assigned to the Command_3; the sequential order of execution ranking “2” is assigned to the Command_1; the sequential order of execution ranking “3” is assigned to the Command_10; and the sequential order of execution ranking “4” is assigned to the Command_9. Upon completing assigning the new sequential order of execution to the commands belonging to the Group 3, the MPU 17 assigns a new sequential order of execution to the commands belonging to the Group 2. More specifically, the sequential order of execution ranking “5” is assigned to the Command_5; the sequential order of execution ranking “6” is assigned to the Command_2; and the sequential order of execution ranking “7” is assigned to the Command_4. Upon completing assigning the new sequential order of execution to the commands belonging to the Group 2, the MPU 17 assigns a new sequential order of execution to the commands belonging to the Group 1. More specifically, the sequential order of execution ranking “8” is assigned to the Command_8; the sequential order of execution ranking “9” is assigned to the Command_7; and the sequential order of execution ranking “10” is assigned to the Command_6. As a result, a new sequential order of execution depicted in FIG. 14 is assigned to the commands held in the command memory 17a.

In this manner, the sequential-order-of-execution changing process is completed. The MPU 17 then sequentially executes the commands held in the command memory 17a in accordance with the sequential order of execution changed at S26.

According to the second embodiment, a command having a longer waiting time can be executed at a higher priority, while allowing effective consecutive accesses determined by the NCQ.

Variations of the first and the second embodiments will now be explained. In these variations, the sequential order of execution is changed within each of the groups.

A variation of the first embodiment will be explained with reference to the functional block diagram depicted in FIG. 3. The selector 102 selects M command(s) from a group to be classified. M herein is an integer equal to or more than one. The classifier 103 classifies the commands belonging to the group to be classified into M+1 subgroups based on the M command(s) selected by the selector 102. The changer 104 assigns a priority to each of the subgroups classified by the classifier 103, based on the waiting time of the M command(s) selected by the selector 102. The changer 104 assigns a priority to the subgroups based on the waiting time of the M command(s) selected by the selector 102. The changer 104 also changes in the groups to be classified, the sequential order of execution for the commands held in the holder 101 so that the commands belonging to a group with a higher priority are executed first.

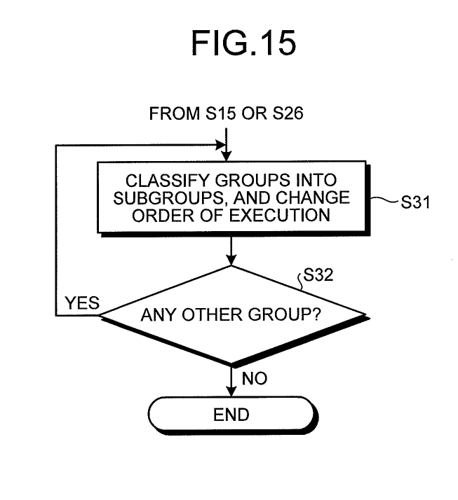

Such a process is realized by the MPU 17 executing the process depicted in the flowchart of FIG. 15 after S15 depicted in FIG. 4. The MPU 17 performs the processes at, for example, S12, S13, S14 and S15 depicted in FIG. 4 to one of the groups (S31). The MPU 17 then determines if any group not having priorities thereof changed is present in the groups (S32). If it is (Yes at S32), the MPU 17 performs the processes at S12, S13, S14, and S15 depicted in FIG. 4 to the group (S31). Upon completing the sequential-order-of-execution changing process for all of these groups, the MPU 17 ends the process (No at S32).

According to this variation of the first embodiment, the sequential order of execution may be changed within a classified group. In the HDD 1, a command having a longer waiting time is executed at a higher priority while allowing effective consecutive accesses determined by the NCQ.

A variation of the second embodiment will now be explained with reference to the block diagram depicted in FIG. 9. The classifier 203 classifies a group to be classified into a plurality of subgroups based on relation values. The extractor 204 extracts a command having the longest waiting time from each of the subgroups. The changer 205 assigns a priority to each of the subgroups further classified by the classifier 203 based on the waiting time of each of the extracted commands. The changer 205 also changes the sequential order of execution for the commands held in the holder 201 so that the commands belonging to a subgroup having a higher priority are executed first within the group.

Such a process is realized by the MPU 17 executing the process depicted in the flowchart of FIG. 15 after S26 depicted in FIG. 10. The MPU 17 performs the processes at, for example, S22, S23, S24, S25, and S26 depicted in FIG. 10 to one of a plurality of groups (S31). The MPU 17 then determines if any group not having priorities changed is present in the groups (S32). If it is (Yes at S32), the MPU 17 performs the processes at S22, S23, S24, S25 and S26 depicted in FIG. 10 to the group (S31). Upon completing the sequential-order-of-execution changing process for all of these groups, the MPU 17 ends the process (No at S32).

According to this variation of the second embodiment, the sequential order of execution may be changed within a classified group. In the HDD 1, a command having a longer waiting time is executed at a higher priority while allowing effective consecutive accesses determined by the NCQ.

According to an embodiment of the invention, it is possible to execute consecutive accesses to a recording medium effectively while prioritizing execution of a command that has been waiting for a long time period to be executed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A controller comprising:
a memory configured to store a plurality of commands pre-assigned with a sequential order of execution and to store waiting times indicating elapsed time periods from when the plurality of commands were stored;
a selector configured to select N commands comprising the longest waiting times from the plurality of commands, where N is a natural number;
a classifier configured to classify the plurality of commands into N+1 groups such that the N commands selected by the selector are comprised in different groups; and
a priority sorter configured to assign priorities to the N+1 groups based on the waiting times of the N commands selected by the selector, and to change the sequential order of execution for the plurality of commands such that commands in a group comprising a high priority are executed first.

2. The controller of claim 1, wherein the priority sorter is configured to change the sequential order of execution for plural commands in accordance with the pre-assigned sequential order of execution, if the plural commands are in a group.

3. The controller of claim 1, wherein the selector is configured to determine the number N of commands to be selected based on a number of commands in the memory.

4. The controller of claim 1, wherein the classifier is configured to classify the plurality of commands into the N+1 groups such that the selected N commands comprise highest rankings in a sequential order of execution within the groups which comprise the commands.

5. The controller of claim 1, wherein the sequential order of execution pre-assigned to the plurality of commands in the memory is in accordance with the Native Command Queuing.

6. A controller comprising:
a memory configured to store a plurality of commands pre-assigned with a sequential order of execution;
a relation value calculator configured to calculate relation values indicating relationships between adjacent commands in the sequential order of execution for the plurality of commands;
a classifier configured to classify the plurality of commands into a plurality of groups based on the relation values calculated for the plurality of commands;
an extractor configured to extract commands comprising longest waiting times indicating elapsed time periods from when the commands were in the memory for the plurality of groups; and
a priority sorter configured to assign priorities to the plurality of groups based on the waiting times extracted by the extractor, and to change the sequential order of execution for the plurality of commands such that commands in a group comprising a high priority are executed first.

7. The controller of claim 6, wherein the priority sorter is configured to change the sequential order of execution for plural commands in accordance with the pre-assigned sequential order of execution if the plural commands are in a group.

8. The controller of claim 6, wherein the relation value calculator is configured to calculate a transition time period from completion of a prior command in the sequential order of execution to execution of a subsequent command in the sequential order of execution as the relation value for the prior and subsequent commands in the sequential order of execution.

9. The controller of claim 6, wherein the relation value calculator is configured to calculate a difference between a logical address accessed by a prior command in the sequential order of execution and a logical address accessed by a subsequent command in the sequential order of execution as the relation value for the prior and subsequent commands in the sequential order of execution.

10. The controller of claim 6, wherein
the classifier is configured to classify a classified group into a plurality of subgroups based on the relation value;
the extractor is configured to extract commands comprising longest waiting times from the plurality of subgroups; and
the priority sorter is configured to assign priorities to the plurality of subgroups based on the waiting times extracted by the extractor, and to change the sequential order of execution for the plurality of commands such that commands in a subgroup comprising a high priority are executed first.

11. The controller of claim 6, wherein the sequential order of execution pre-assigned to the plurality of commands in the memory is in accordance with the Native Command Queuing.

12. A storage device comprising:
a memory configured to store a plurality of commands pre-assigned with a sequential order of execution and to store waiting times indicating elapsed time periods from when the plurality of commands were stored;
a selector configured to select N commands comprising the longest waiting times from the plurality of commands, where N is a natural number;
a classifier configured to classify the plurality of commands into N+1 groups such that the N commands selected by the selector are comprised in different groups;
a priority sorter configured to assign priorities to the N+1 groups based on the waiting times of the N commands selected by the selector, and to change the sequential order of execution for the plurality of commands such that commands in a group comprising a high priority are executed first; and
a command executor configured to sequentially execute the plurality of commands in accordance with the sequential order of execution changed by the priority sorter.

13. The storage device of claim 12, wherein the priority sorter is configured to change the sequential order of execution for plural commands in accordance with the pre-assigned sequential order of execution if the plural commands are in a group.

14. The storage device of claim 12, wherein the selector is configured to determine the number N of commands to be selected based on a number of commands in the memory.

15. The storage device of claim 12, wherein the classifier is configured to classify the plurality of commands into the N+1 groups such that the selected N commands comprise highest rankings in a sequential order of execution within the groups which comprise the commands.

16. The storage device of claim 12, wherein the sequential order of execution pre-assigned to the plurality of commands in the memory is in accordance with the Native Command Queuing.
